(19) United States
(12) Patent Application Publication
(10) Pub. No.: US 2014/0179578 A1
(43) Pub. Date: Jun. 26, 2014

(54) ALTERNATING BLOCK COPOLYMER AND PROCESS FOR MAKING

(71) Applicant: EXXONMOBIL RESEARCH AND ENGINEERING COMPANY, Anandale, NJ (US)

(72) Inventors: Andy Haishung Tsou, Allentown, PA (US); Yong Yang, Annandale, NJ (US); Martin N. Webster, Pennington, NJ (US); Thomas Sun, Clinton, NJ (US); Johannes Mattieu Soulages, Morristown, NJ (US); Donna Jean Crowther, Seabrook, TX (US); C. Rebecca Locker, Annandale, NJ (US)

(73) Assignee: EXXONMOBIL RESEARCH AND ENGINEERING COMPANY, Annandale, NJ (US)

(21) Appl. No.: 13/726,304

(22) Filed: Dec. 24, 2012

(51) Int. Cl. C10M 145/14; C08F 299/04

(52) U.S. Cl. CPC C10M 145/14; C08F 299/04
USPC 508/472; 525/299

(57) ABSTRACT

Provided is an alternating block copolymer. The alternating block copolymer has an olefin polymer block and an poly(alkyl methacrylate) block. The olefin polymer block has monomeric units of one or more alpha olefins of 2 to 12 carbon atoms that make up 90 wt % or more of the total weight of the olefin polymer block. The olefin polymer block exhibits a number average molecular weight of the olefin polymer block is 1000 to 500,000. The poly(alkyl methacrylate) block has monomeric units of one or more alkyl methacrylates with alkyl side chains of 1 to 100 carbon atoms that make up 90 wt % or more of the total weight of the poly(alkyl methacrylate) block. The poly(alkyl methacrylate) block exhibits a number average molecular weight of 1000 to 500,000. There is also provided a lubricant composition containing the alternating block copolymer and a process for making the alternating block copolymer.

### FIELD

The disclosure relates to an alternating block copolymer. The disclosure also relates to process for making the alternating block copolymer. The disclosure also relates to a lubricant composition containing the alternating block copolymer.

### BACKGROUND

Viscosity modifiers (VM) are employed in the lubricant base stocks to reduce the change in viscosity with temperature. Viscosity index (VI) is a term used to characterize this reduction. Larger VI values correspond to smaller reductions in viscosity with temperature and have been used as a measure of lubricant quality. Pennsylvania grade oils with 100 VI are used by the industry as the relative standard.

A VM desirably exhibits a high degree of thickening capability, i.e., relatively large increase in viscosity in the base stocks for the amount of VM used, A VM that exhibits a high degree of thickening capability typically exhibits large VM coil dimension in a base stock. Other desirable properties for a VM include shear stability, thermo-oxidative stability, a favorable low temperature viscometric, early onset of shear thinning, and a positive temperature coefficient. When a VM has a positive temperature coefficient in a lubricant base stock, viscosity of the VM containing base stock solution increases with temperature.

Five different classes of VM are currently employed by the industry in lubricant base stocks. The classes include OCPs (olefin copolymers). SIPs (hydrogenated styrene-isoprene copolymers), PMAs (polymethacrylates), SPE (esterified poly(styrene-co-maleic anhydride), and PMA/OCP compatibilized blends. The most commonly used VMs are OCPs, SIPs, and PMAs. The various classes of VM are described in Chemistry and Technology of Lubricants (P. M. Mortier and S. T. Orszulik, 2^{nd} Ed., Mackie Academic, New York, Chapter 5).

No single class of VM provides all the desired performance characteristics. OCPs exhibit the highest thickening capability but exhibit a negative temperature coefficient, a poor low temperature viscometric, and are prone to shear degradation. SIPs exhibit moderate thickening capability, but also have a negative temperature coefficient and are prone to thermo-oxidative degradation because of the polystyrene component. PMAs exhibit poor thickening capability but are the only VM class that exhibits a positive temperature coefficient and excellent low temperature viscosity behavior. SPEs exhibit even lower thickening efficiency than that of PMAs and are prone to thermo-oxidative degradation but exhibit good low temperature properties. SPEs are used primarily in lubricant base stocks that exhibit higher polarity. PMA/OCP blends are used primarily with a polar solvent dispersant in lubricants to ensure that PMA remains the matrix phase whereas the OCP is the dispersed phase. PMA/OCP blends exhibit the same drawbacks as OCPs.

The only commercial diblock and triblock VMs currently available are in the SIP family with styrene-hydrogenated isoprene (hI) or styrene-hI-styrene linear block compositions. The styrene blocks have Mw ranging from 30K to 50K and the molecular weights of hI blocks range from 50K to 100K. These block VMs form micelles in paraffinic oils and in synthetic base stocks of PAOs. However, they do not form micelles in alkylated naphthalene (AN) base stocks or in some aromatic oils. With micelle formation, they function as associative thickeners with good thickening efficiency. Also, due to the ease which micelles break up under shear, they can exhibit earlier onset of shear thinning and good resistance to shear degradation. However, these block VMs are prone to thermo-oxidative degradation because of the polystyrene content and they still exhibit a negative temperature coefficient.

### SUMMARY

According to the present disclosure, there is provided an alternating block copolymer. The alternating block copolymer has an olefin polymer block and a poly(alkyl methacrylate) block. The olefin polymer block has monomeric units of one or more alpha olefins of 2 to 12 carbon atoms that make up 90 wt % or more of the total weight of the olefin polymer block. The olefin polymer block exhibits a number average molecular weight of the olefin polymer block is 1000 to 500,000. The poly(alkyl methacrylate) block has monomeric units of one or more alkyl methacrylates with alkyl side chains of 1 to 100 carbon atoms that make up 90 wt % or more of the total weight of the poly(alkyl methacrylate) block. The alkyl methacrylate block exhibits a number average molecular weight of 1000 to 500,000.

Further according to the present disclosure, there is provided a lubricant composition. The composition has a lubricant base stock and 0.1 wt % to 20 wt % of the alternating block copolymer described above based on the total weight of the composition.

Further according to the present disclosure, there is provided a process for making an alternating block copolymer of an olefin polymer block and an alkyl methacrylate block. The process has the steps of (a) providing the olefin polymer block, (b) preparing a olefin polymer block with chain end unsaturations, (c) forming an ATRP macroinitiator with the chain-end unsaturated olefin polymer block to prepare an olefin polymer block macroinitiator, and (d) reacting the olefin polymer block macroinitiator with one or more alkyl methacrylates with alkyl side chains of 0 to 100 carbon atoms to form the poly(alkyl methacrylate) block. The olefin polymer block has monomeric units of one or more alpha olefins of 2 to 12 carbon atoms making up 90 wt % or more of the total weight of the olefin polymer block and exhibits a number average molecular weight of 1000 to 500,000. The alkyl methacrylate block has one or more alkyl methacrylates with alkyl side chains of 0 to 100 carbon atoms making up 90 wt % or more of the total weight of the poly(alkyl methacrylate) block and exhibits a number average molecular weight of 1000 to 500,000.

### BRIEF DESCRIPTION OF THE FIGURES

FIG. 1 is a plot of a CMC (Critical Micelle Concentration) curve for SV140, a comparison diblock copolymer, in PAO4.

FIG. 2 is a ¹H NMR spectrum of a vinyl terminated aPP.

FIG. 3 is a GPC curve of a vinyl terminated aPP.

FIG. 4 is a NMR spectrum of an ATRP macroinitiator.

FIG. 5 is a ¹H NMR spectrum of an aPP-b-PBMA copolymer in Example 2A.

FIG. 6 is a GPC-3D of an aPP-b-PBMA copolymer in Example 2A.

FIG. 7 is a ¹H NMR spectrum of an aPP-b-PODMA copolymer in Example 8.

FIG. 8 is a GPC-3D of an aPP-b-PODMA copolymer in Example 8.

FIG. 9 is a ¹H NMR Spectrum of an aPP-b-PEHMA copolymer in Example 9.

FIG. 10 is a GPC of an aPP-h-PEHMA copolymer in Example 9.

### DETAILED DESCRIPTION

All numerical values within the detailed description and the claims herein are modified by “about” or “approximately” the indicated value, and take into account experimental error and variations that would be expected by a person having ordinary skill in the art.

In the present disclosure, alternating block copolymers are prepared that are micelle-forming, associative thickeners and exhibit excellent thickening efficiency, shear stability, thermo-oxidative stability, favorable low temperature properties, early shear thinning onset, and positive temperature coefficient. The block copolymers are suitable for improving the viscometric behavior of lubricants.

The block copolymers have alternating miscible and immiscible blocks (miscibility/immiscibility in hydrocarbon solvents). The alternating miscibility/immiscibility is to ensure micelle or vesicle formation by the block copolymers in hydrocarbon solvents and lubricant base stocks. The micelle/vesicle formation maximizes thickening capability, provides earlier onset of shear thinning, and minimizes shear degradation. Useful block copolymer configurations include, for example, diblocks, triblocks, and tetrablocks.

The miscible blocks are preferred to be amorphous homo or copolymers of linear alpha olefins with carbon numbers of 12 or less and preferably 2 to 8 that exhibit high miscibility in aliphatic hydrocarbon solvents, particularly synthetic lubricant base stocks of poly alpha olefins (PAOs). Number average molecular weights of the miscible blocks are preferred to be from 1,000 to 500,000, more preferably from 2500 to 400,000, and most preferably from 5000 to 300,000. The miscibility requirement is to ensure solubility of these block copolymers in hydrocarbon solvents and hydrocarbon lubricant base stocks. Examples of useful homopolymer/copolymer blocks include amorphous ethylene-propylene, ethylene-butene, ethylene-hexene, ethylene-octene copolymers, atactic propylene homopolymer, propylene-butene, propylene-hexene, and propylene-octene. These olefins are inclusive of any isomeric derivatives, such as n- and iso-.

Compositions of the immiscible blocks are hydrocarbon polymers with geminal di-substitution that have limited solubility or miscibility in aliphatic hydrocarbon solvents. The limited miscibility promotes micelle/vesicle formation and the geminal di-substitution imposes backbone conformational constraints for the polymer chain to prefer trans conformation at higher temperatures leading to a coil expansion with temperature. Number average molecular weights of the immiscible blocks are preferred to be from 1000 to 500,000, more preferably from 2500 to 400,000, and most preferably from 5000 to 300,000. Amorphous poly(alkyl methacrylate)s preferably have an alkyl side chain length of C₁ to C₁₀₀, more preferably from C₂ to C₅₀, and most preferably from C₃ to C₂₄. Useful poly(alkyl methacrylate)s include but are not limited to poly(methyl methacrylate), poly(octadecyl methacrylate), poly(dodecyl methacrylate), poly(hexadecyl methacrylate), poly(butyl methacrylate, poly(2-ethylhexyl methacrylate). Poly(alkyl methacrylate), instead of poly(methyl methacrylate) (PMMA), is necessary to ensure germinal di-substitution and limited solubility in hydrocarbon solvents. The PMMA block is completely immiscible in hydrocarbon solvents and the resulting block copolymers cannot be dispersed in hydrocarbon solvents for micelle formation. Additionally, it is preferred to have a branched alkyl side chain when the side chain carbon number is greater than 10 to prevent the side chain from crystallization.

There is also a process for making an alternating block copolymer according to the present disclosure. A vinyl-terminated olefin polymer is formed from the olefin polymer. The vinyl-terminated olefin polymer is converted to an ATRP macroinitiator via chemical transformations. The ATRP macroinitiator is reacted with one or more alkyl methacrylates to form the poly(alkyl methacrylate) block via atom transfer radical polymerization (ATRP).

Vinyl-terminated polyolefins can be prepared according to any processes known in the art. Any conventional process, such as suspension, homogeneous bulk, solution, slurry, and high-pressure oligomerization, can be used. Such processes can be run in a batch, semi-batch, or continuous mode. Examples of such processes are described in U.S. 2009/0318644 and WO 2009155471, both of which are incorporated herein by reference in their entireties.

Vinyl-terminated polyolefins are preferably prepared in a homogeneous process and more preferably a bulk process as described in WO 2009/155471. In a preferred embodiment, propylene and optional comonomers such as ethylene can be polymerized by reacting a catalyst system (e.g., metallocene compound(s) and one or more activators) with the olefins. Other additives may also be used, as desired, such as scavengers and/or hydrogen. Homogeneous polymerization processes are preferred. A homogeneous polymerization process is a process in which at least 90 wt % of the product is soluble in the reaction media. A bulk homogeneous process is particularly preferred. A bulk process is a process in which monomer concentration in all feeds to the reactor is 70 volume % or more. In one embodiment, no solvent or diluent is present or added into the reaction medium (except for the small amounts used as the carrier for the catalyst system or other additives, or amounts typically found with the monomer; e.g., propane in propylene). In another embodiment, the process is a slurry process. A slurry polymerization process is a polymerization process in which a supported catalyst is used and monomers are polymerized on supported catalyst particles. In that process, at least 95 wt % of polymer products derived from the supported catalyst are in granular form as solid particles (not dissolved in the diluent).

The use of vinylidene-terminated olefin polymers is also within the scope of the present disclosure and may be carried out at the same conditions as vinyl termination.

The vinyl-terminated olefin polymer is converted to an ATRP macroinitiator via chemical transformations. A preferred transformation involves 2-bromoisobutyric acid (a reagent), which reacts with the vinyl chain end of the olefin polymer. Useful catalysts include Brφnsted acids such as trifluoromethanesulfonic acid (TfOH). The reaction is carried out at a temperature of −20° C. to 200° C. and preferably from 20° C. to 150° C. The reaction is preferably carried out at ambient pressure. The reaction is carried out for a time of 0.5 hour to 48 hours and preferably from 2 hours to 24 hours. Atom transfer radical polymerization is disclosed, for example, in Preparation of Polyethylene Block Copolymers by a Combination of Postmetallocene Catalysis of Ethylene Polymerization and Atom Transfer Radical Polymerization, Y. Inoue, K. Matyjaszewski, J. Polym. Sci. Part. A: Polym. Chem. 2004, 42, 496-504, which is incorporated herein by reference.

By way of example, the synthesis of an ATRP macroinitiator from a vinyl-terminated olefin polymer (vinyl-terminated atactic polypropylene) is set forth below in Scheme 1:

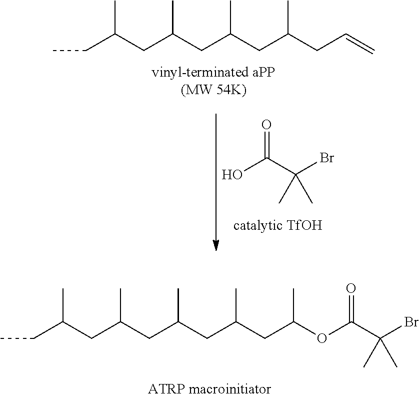

The ATRP macroinitiator is reacted with one or more alkyl methacrylates to form the poly(alkyl methacrylate) block via atom transfer radical polymerization (ATRP). Useful catalysts include copper halide compounds. A particularly useful catalyst system is CuBr. The polymerization is carried out at a temperature of 0° C. to 200° C. and preferably from 30° C. to 150° C. The polymerization is carried out at ambient pressure. The polymerization is carried out for a time of 5 minutes to 96 hours and preferably from 0.5 hour to 60 hours. Polymerization conditions are disclosed, for example, in Preparation of Polyethylene Block Copolymers by a Combination of Postmetallocene Catalysis of Ethylene Polymerization and Atom Transfer Radical Polymerization, Y. Inoue, K. Matyjaszewski, J. Polym. Sci. Part A: Polym. Chem. 2004, 42, 496-504, which is incorporated herein by reference.

By way of example, the synthesis of an alternating block copolymer (aPP-b-PBMA) from an ATRP macroinitiator is set forth below in Scheme 2:

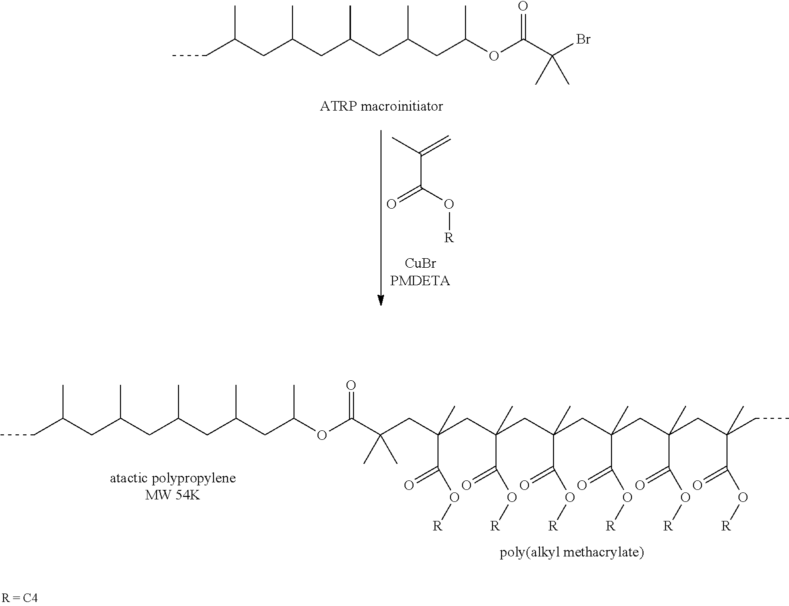

The block copolymers are useful as additives in conventional lubricant base oils and base stocks. The block copolymers will typically be present at 0.1 wt % to 20 wt %, more typically from 0.25 wt % to 10 wt %, and most typically 0.5 wt % to 5 wt %.

Useful lubricating base stocks include natural oils and synthetic oils. Groups I, II, III, IV and IV are broad categories of base stocks developed and defined by the American Petroleum Institute (API Publication 1509) to create guidelines for lubricant base stocks. Group I base stocks have a viscosity index of 80 to 120 and contain greater than 0.03% sulfur and less than 90% saturates. Group II base stocks have a viscosity index of 80 to 120, and contain less than or equal to 0.03% sulfur and greater than or equal to 90% saturates. Group III stocks have a viscosity index greater than 120 and contain less than or equal to 0.03% sulfur and greater than 90% saturates, Group IV includes polyalphaolefins (PAO). Group V base stock includes base stocks not included in Groups I-IV.

The following are examples of the present disclosure and are not to be construed as limiting.

### EXAMPLES

Diblock copolymers of the present disclosure were prepared and evaluated form viscometric properties. Further, commercially available diblock copolymers not of the present disclosure and polymer resins not of the present disclosure were also evaluated for viscometric properties for basis of comparison.

### Micelle Formation of a Diblock VM (not of the Present Disclosure)

PAO4 (Polyalpha olefin, 4 cps, ExxonMobil Chemical) was selected as the base stock. 0.5 wt % of Lubrizol OCP (LzOCP) (propylene-butene copolymer, Lubrizol), SV140 (diblock SIP, Infineum), and SV200 (star SIP. Infineum) viscosity modifiers were added into PAO4. Shear viscosity values of PAO4 and PAO4 containing 0.5 wt % OCP, SV140, and SV200 were measured as a function of shear rate using an Anton-Paar cone on plate rheometer (shear rates from 1 to 10,000 l/s), a m-VROC micro capillary rheometer (shear rates from 10⁴ to 10⁶ l/s), and an ultra-high shear coquette viscometer (shear rates from 10⁶ to 10⁸ l/s) at temperatures of 25° C., 50° C., 75° C., 100° C., 125° C., and 150° C. Using time-temperature superposition, a master shear viscosity curve was obtained for each solution covering the shear rates from 1 to 10⁸ l/s and the curve was fitted to a Carreau equation. The onset of the shear thinning for each solution was determined based on the >5% drop in viscosity value. The corresponding shear rates for the shear thinning onset for all solutions are tabulated in Table 1. SV140, the diblock VM, has the lowest shear thinning onset shear rate.

TABLE 1
(Shear thinning onset of PAO4 and
PAO4 containing 0.5 wt % VM)

| | Shear Thinning Onset Shear Rate |
|---|---|
| Solution | (1/s) |
| PAO4 | None (Newtonian, no shear |
| | thinning) |
| PAO4 + Lubrizol OCP | 100,000 |
| PAO4 + SV140 | 20,000 |
| PAO4 + SV200 | 200,000 |

Dynamic light scattering measurements were performed on the control PAO4 solvent and PAO4 solutions containing various dilute concentrations of SV140 to determine critical micelle concentration (CMC) of SV140 in PAO4. Both multiple-angle static and dynamic light scattering measurements were conducted using a Wyatt Dawn Heleos II instrument equipped with a flow cell that has an antireflective coating operated from 0° C. to 140° C. with <1% baseline fluctuations. The dynamic light scattering measures the hydrodynamic radius of the SV140 inside PAO4. As shown in FIG. 1, the CMC thr SV1.40 in PAO4 is 0.001 wt %. Above the CMC, SV140 forms micelles with sizes ranging from 60 to 70 nm in radius. The single coil of SV140 below the CMS has the size 5 nm in radius. The presence of SV140 micelles in PAO4 may account for the early shear thinning onset indicated in Table 1.

### Positive Temperature Coefficient of PHDMA

The shear viscosity of the dilute polymer solutions and the PAO solvent was measured using a double gap Couette flow cell on a stress-controlled MCR501 rheometer from Anton-Paar. The solution sample was loaded at room temperature and the flow cell was set at −30° C. and the temperature was ramped from −30° C. to 150° C. with 10° C. increments. At each temperature, the solution shear viscosity was measured for shear rates ranging from 1 to 2000 l/s. The intrinsic viscosity was determined by extrapolating to zero concentration using the Huggins equation. The intrinsic viscosity can be used as a measure of the viscometric radius (Rv) of a polymer coil in a dilute solution. Hydrogenated linear polyisoprene, hPI (poly(ethylene-alt-propylene) after hydrogenation, 170K Mw, synthesized by anionic polymerization), atactic polypropylene, aPP (290K Mw, synthesized by metallocene coordination polymerization), poly(hexadecyl-methacrylate), PHDMA (200K Mw, Aldrich), SV140, SV200, and Lubrizol OCP (LzOCP) were examined. As shown in Table 2, only PHDMA shows an increase in Rv, or an increase in viscosity, with temperature. All other polymers evaluated in PAO4 show a decrease in viscosity with temperature, or a negative temperature coefficient.

TABLE 2
(Polymer Coil Dimensional Change with
Temperature (from 0° C. to 140° C.))

| Polymers | Rv |
|---|---|
| hPI | Decrease |
| aPP | Decrease |
| PHDMA | Increase |
| SV140 | Decrease |
| SV200 | Decrease |
| LzOCP | Decrease |

Long chain branched star SV200 and micelle-forming SV140 have the same temperature dependence as that of a linear hPI. The second virial coefficient, which is a measure of the polymer-solvent interaction, can be obtained from the excess scattering intensity from the multi-angle light scattering experiments. Values of the second virial coefficient of hPI, aPP, and PHDMA were obtained from 20° C. to 140° C. in PAO4. A weak to no dependence on temperature can be seen for the second virial coefficients measured. This result suggests that the coil expansion in PHDMA and contraction in hPI and aPP are not controlled by the polymer-solvent interaction.

### Conformation Preference of Geminal Di-substituted Backbone

Molecular dynamics simulations in a canonical (NVT) ensemble were run using the Amorphous Cell module of Accelrys Materials Studio software. Each oligomer was simulated in an explicit solvent. The systems were equilibrated for 10 picosecond (ps). Oligomer coordinates were collected every 5000 femtoseconds (fs) for at least 100 picoseconds (ps) at two temperatures (289° K and 373° K). The torsion angle and radius of gyration probability distributions were computed from the set of oligomer coordinates. The calculated Rg (radius of gyration) increase or decrease with temperature based on the torsion angle preference from molecular dynamics simulation results is tabulated in Table 3 for polyethylene (PE), atactic polypropylene (aPP), polyisobutylene (PIB), and alternated ethylene-isobutylene (alt E-IB) copolymer. Isobutylene is selected to represent PHDMA since it has a geminal dimethyl substitution similar to PHDMA that has geminal substitution of methyl and hexadecyl ester. As indicated in Table 3, the conformational dependence on temperature may be the governing factor in deciding coil contraction or expansion with temperature of hydrocarbon polymers in a hydrocarbon solvent.

TABLE 3
(Oligomer coil dimensional change with
temperature (simulation results))

| | Increase/Decrease with |
|---|---|
| Polymer | Temperature |
| PE | Decrease |
| aPP | Decrease |
| PIB | No Change |
| alt E-IB | Increase |

A vinyl terminated aPP (VT aPP) is synthesized in sequential steps as set forth below. The vinyl terminated aPP is then subsequently used to prepare alternating diblock copolymers with different alkyl methacrylates.

### Synthesis of Vinyl Terminated aPP Macromer

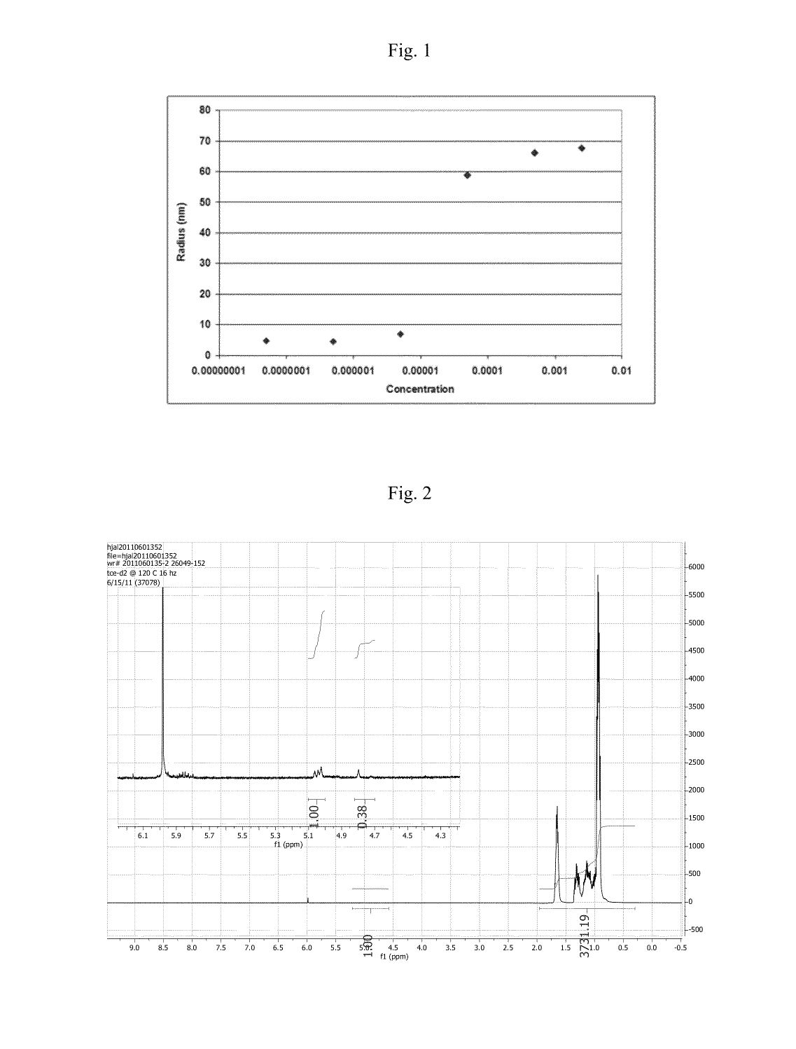

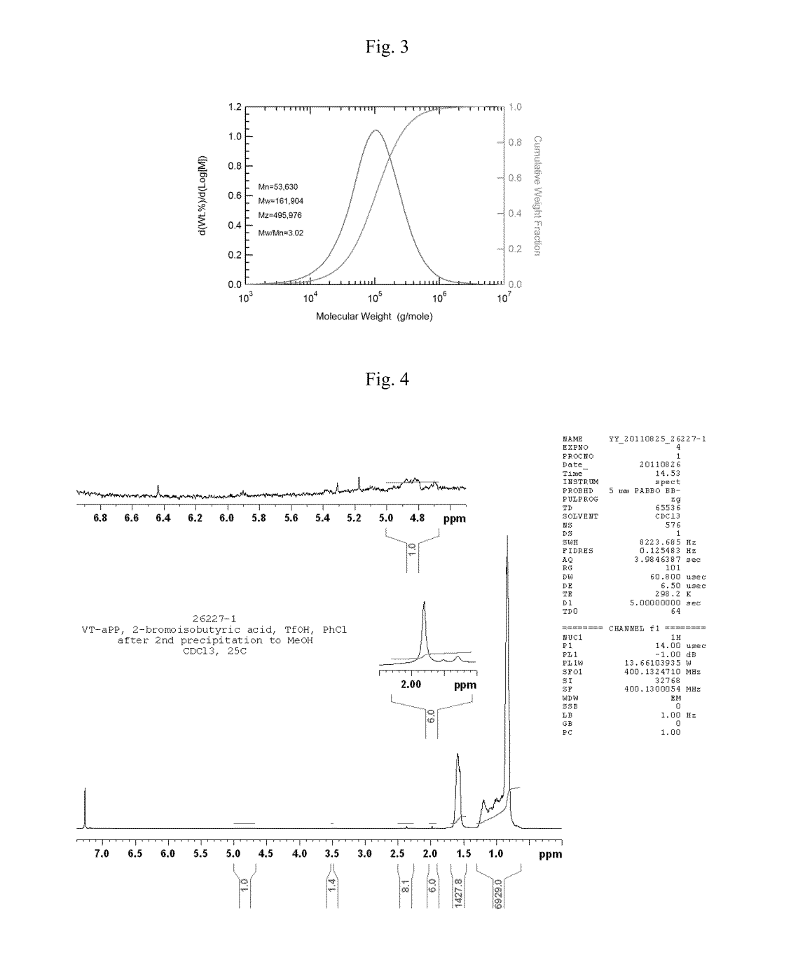

Polymerization of propylene was performed in a 2 liter (L) stainless steel autoclave conditioned by steam heating and maintained under a N₂ atmosphere. Triisobutylaluminum (0.5 mL, 1.0 M) was added via syringe followed by propylene (800 mL). The stirrer was maintained at 900 rpm and the autoclave contents heated to 45° C. A catalyst solution in 5 mL, of toluene (containing 3 mg of rac-dimethylsilylbis(2-methyl,3-propylindenyl)hafnium dimethyl catalyst and 6 mg of dimethylanilinium tetrakisperfluoronapthylborate activator) were added by N₂ pressurized catalyst tube. The polymerization proceeded for 17 minutes at which time the reaction was cooled and excess pressure slowly vented away. The contents were dissolved in hexane (200 mL) and transferred into a glass vessel. After removing volatiles, the product was dried in vacuo at 70° C. for 12 hours, A NMR spectrum of the VT aPP is shown in FIG. 2. A GPC curve for same is shown in FIG. 3.

### Synthesis of ATRP Macroinitiator from Vinyl Terminated aPP (VT aPP)

A 100 mL round-bottom flask was charged with 2.3742 g vinyl-terminated atactic polypropylene (VT aPP, MW 54K) and 24.5 mL, chlorobenzene. The mixture was heated to 100° C. to dissolve the VT aPP, after which 1.4772 grams of 2-bromoisobutyric acid was added to the flask. Then 0.5 mL chlorobenzene solution containing 0.002 gram of trifluoromethane sulfonic acid (TfOH) was injected to the reaction flask. The reaction mixture was stirred at 100° C. for 18 hours. After cooling down, the reaction mixture was dropped slowly into a stirring 500 mL methanol to precipitate out the polymer product.

The methanol was decanted and fresh methanol was added. After stirring for 15 minutes, the methanol was decanted. The process was repeated two more times. The reaction scheme is shown in scheme 1 above.

The white polymer was placed in a vacuum oven at 80° C. overnight. A ¹H NMR spectrum of this product indicated that it contained free 2-bromoisobutyric acid (FIG. 4. The polymer was then re-dissolved in toluene and added slowly dropwise to a 500 mL stirring methanol. The methanol was decanted and the same rinsing process was repeated for three more times. The white polymer was placed in a vacuum oven at 60° C. overnight. The dried polymer turned slightly grey and transparent. The recovered final product was 2.2 grams (93% yield). ¹H NMR of this purified product (FIG. 4) showed the CH proton next to ester (indicating the formation of macroinitiator) and the isobutyl protons was at 1:6 ratio, implying no free 2-bromoisobutyric acid was left. An elemental analysis of this product showed 0% bromine (Br). The theoretical Br content is 0.14%, which is below the detecting limit of conventional Br elemental analysis. The Br elemental analysis further confirmed there was no free 2-bromoisobutyric acid left, which ensured that the next ATRP polymerization is initiated by the aPP macroinitiator to form diblock copolymers but not from the 2-bromoisobutyric acid to form a blend of two homopolymers.

### Examples 1, 2, and 2A

### Synthesis of aPP-b-PBMA Diblock Copolymer

In Examples 1, 2, and 2A, aPP-b-PBMA diblock copolymers were prepared. The same methodology was employed except the reaction time varied. The longer the reaction time, the greater the molecular weight. The particular methodology set forth below corresponds to that of Example 2A. Examples 1 and 2 used lesser reaction times than Example 2A. Molecular weights and hydrodynamic radii for each of related Examples 1 and 2 are set forth below in Table 4.

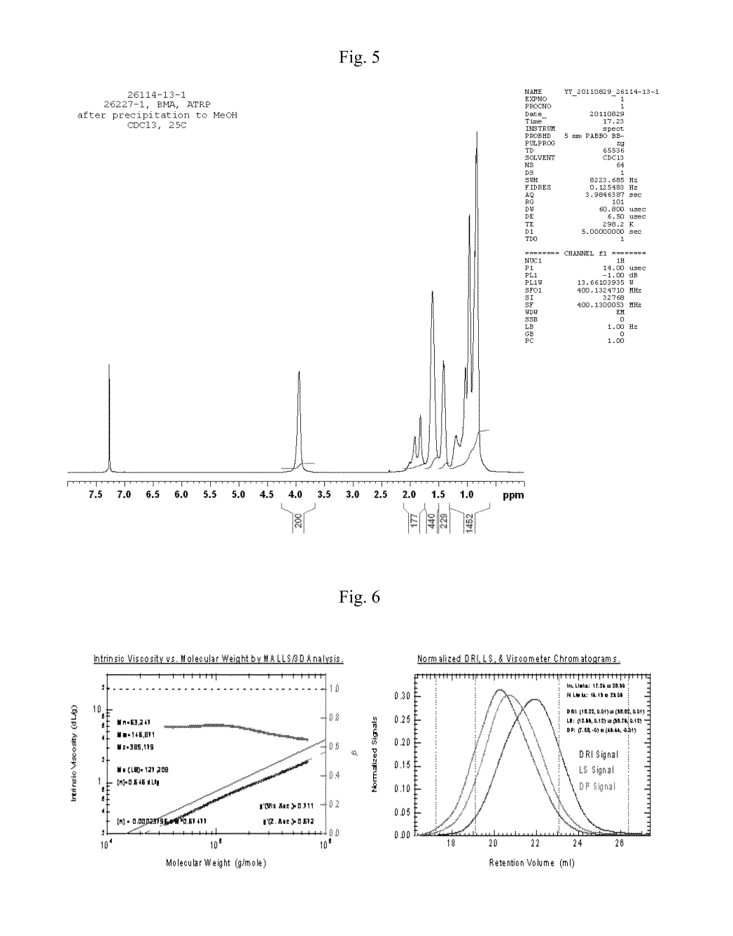

A 50 mL round-bottom flask was charged with 0.45 gram aPP macroinitiator, 0.143 grain CuBr and 10 mL toluene. The mixture was stirred to dissolve the aPP macroinitiator. Then 8 mL butyl methacrylate (BMA) was injected into the flask. After mixing, 0.21 mL pentamethyldiethylenetriamine (PMDETA) was injected to initiate the reaction. The reaction mixture was heated at 100° C. for 60 hours. After cooling down, the reaction mixture was dropped slowly into a stirring 500 mL methanol to precipitate out the polymer product. The methanol was decanted and fresh methanol was added. After stirring for 15 minutes, the methanol was decanted. The process was repeated two more times. The polymer was placed in a vacuum oven at 60° C. overnight. The product was re-dissolved in a small amount of toluene and precipitated to 500 mL methanol. The same rinsing process was repeated for three times. The purified polymer was dried in a vacuum oven at 40° C. over the weekend. Base on the ¹H NMR of this purified product (see FIG. 5), it can be estimated that its structure is a diblock copolymer with a 54K aPP block and a 100K PBMA block (overall 154K MW) with an isolated yield of 86%. As indicated by the GPC-3D (FIG. 6) plot, the MW of this diblock copolymer is 147K. The GPC traces are unimodal, which further confirms the diblock nature.

### Examples 3 to 8

### Synthesis of aPP-b-PODMA Diblock Copolymer

In Examples 3 to 8, aPP-b-PODMA diblock copolymers were prepared. The same methodology was employed except the reaction time varied. The longer the reaction time, the greater the molecular weight. The particular methodology set forth below corresponds to that of Example 8. Molecular weights and hydrodynamic radii for each of Examples 3 to 8 is set forth below in Table 4.

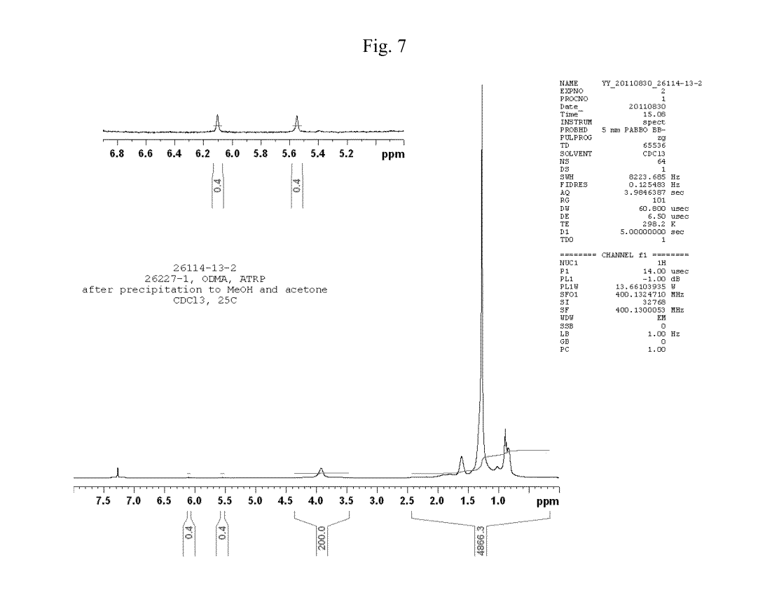

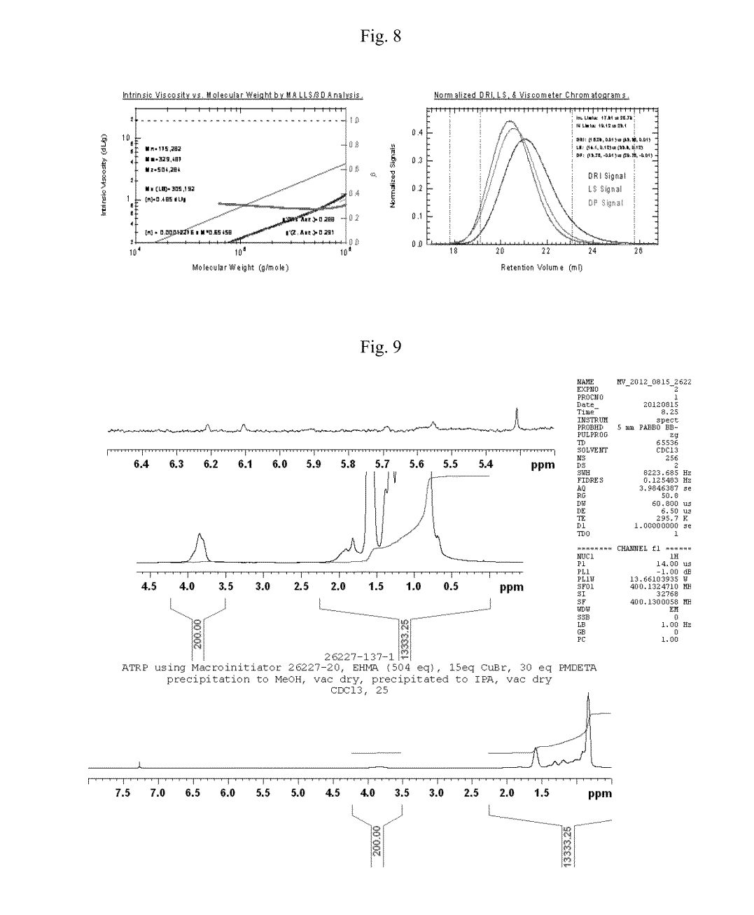

A 50 mL round-bottom flask was charged with 0.53 gram aPP macroinitiator, 0.143 grant CuBr and 15 mL toluene. The mixture was stirred to dissolve the aPP macroinitiator. Then 6.77 gram octadecyl methacrylate (ODMA) was added into the flask. After mixing, 0.21 mL pentamethyldiethylenetriamine (PMDETA) was injected to initiate the reaction. The reaction mixture was heated at 100° C. for 60 hours. After cooling down, the reaction mixture was dropped slowly into a stirring 500 mL methanol to precipitate out the polymer product. The polymer was filtered and fresh methanol was added. After stirring for 15 minutes, the polymer was filtered. The process was repeated two more times. The polymer was placed in a vacuum oven at 60° C. overnight. The product was re-dissolved in a small amount of toluene and precipitated to 500 mL isopropanol. The same rinsing process was repeated for three times. The purified polymer was dried in a vacuum oven at 40° C. over the weekend. Based on the ¹H NMR (FIG. 7) of this purified product, it can be estimated that its structure is a diblock copolymer with a 54K aPP block and a 302K PODMA block (overall 356K MW) with an isolated yield of 97%. As shown in the GPC-3D plot (FIG. 8), the MW of this diblock copolymer is 329,000. The GPC traces are unimodal, further confirming the diblock nature.

### Example 9

### Synthesis of aPP-b-PERMA Diblock Copolymer

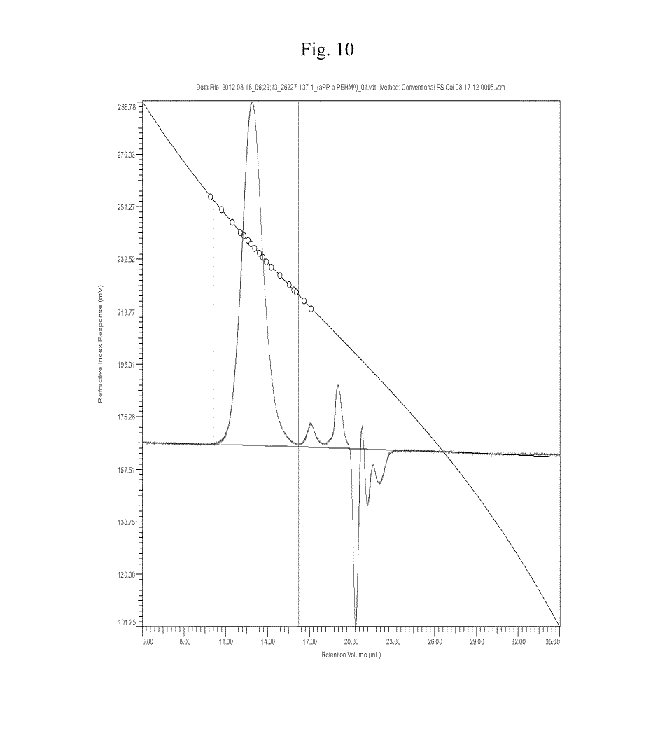

A 50 mL round-bottom flask was charged with 0.54 gram aPP macroinitiator, 0.0215 gram CuBr and 5 mL toluene. The mixture was stirred to dissolve the aPP macroinitiator. Then 1 gram 2-ethylhexyl methacrylate (EHMA) was added into the flask. After mixing, 0.061 mL pentamethyldiethylenetriamine (PMDETA) was injected to initiate the reaction. The reaction mixture was heated at 90° C. for 60 hours. After cooling down, the reaction mixture was dropped slowly into a stirring 500 mL methanol to precipitate out the polymer product. The polymer was filtered and fresh methanol was added. After stirring for 15 minutes, the polymer was filtered. The process was repeated two more times. The polymer was placed in a vacuum oven at 60° C. overnight. The product was re-dissolved in a small amount of toluene and precipitated to 500 mL isopropanol. The same rinsing process was repeated for three times. The purified polymer was dried in a vacuum oven at 40° C. over the weekend. Based on the ¹H NMR (FIG. 9) of this purified product, it can be estimated that its structure is a diblock copolymer with a 54K aPP block and a 13.5K PEHMA block (overall 67.5K Mn) with an isolated yield of 98%. The overall Mn of this diblock copolymer is determined to be 62,903 by GPC. As shown in the GPC plot (FIG. 10), the trace is unimodal, further confirming the diblock nature. Molecular weight and hydrodynamic radius for Example 9 is set forth below in Table 4.

Micelle Formation of aPP-PMA in PAO

Two aPP-b-PBMA copolymers (Examples 1 and 2), six aPP-b-PODMA copolymers (Examples 3-0.8), and one aPP-b-PEHMA copolymer (Example 9) as listed in Table 4 were dissolved in PAO4 (ExxonMobil Chemical, PAO of 4 centistokes (cSt) kinematic viscosity) respectively and their micelle sizes were measured by dynamic light scattering at 25° C. All diblock copolymers have the same 54,000 molecular weight for the aPP block. As shown in Table 4, the hydrodynamic radii of all these diblock copolymers are greater than 50 nm suggesting the micelle formation since the single coil of each diblock copolymer is expected to be less than 10 nm in radius. The CMC value for Example 8 was measured and the value is 0.026 wt %. The CMC value for Example 9 was measured and the value is 0.04 wt %. This is another indicator for the formation of micelles in these diblock copolymers in PAO4.

TABLE 4
(Hydrodynamic radii of aPP-PMA diblock copolymers)

| | PMA type in aPP-b- | | Rh at 25° C. |
|---|---|---|---|
| Example | PMA | Mn of PMA | (nm) |
| 1 | PBMA | 1,500 | 65 |
| 2 | PBMA | 2,500 | 69 |
| 3 | PODMA | 3,400 | 53 |
| 4 | PODMA | 14,100 | 61 |
| 5 | PODMA | 32,200 | 65 |
| 6 | PODMA | 194,000 | 60 |
| 7 | PODMA | 240,000 | 68 |
| 8 | PODMA | 302,000 | 68 |
| 9 | PEHMA | 13,500 | 23 |

The shear viscosity of the dilute polymer solutions of Example 8 in PAO4 and the PAO solvent was measured using a double-gap Couette flow cell on a stress-controlled MCR501 rheometer (Anton-Paar). The solution sample was loaded at room temperature and the flow cell was set at 0° C. and the temperature was ramped from 0° C. to 150° C. with 10° C. increments. The intrinsic viscosity was obtained by extrapolating to zero concentration using the Huggins equation. The intrinsic viscosity was found to increase with increasing temperature from 30° C. to 150° C. of PAO solution containing Example 8.

The hydrodynamic radius of the dilute polymer solution of Example 9 in PAO4 was measured using dynamic light scattering. The hydrodynamic radius was found to increase with increasing temperature from 20° C. to 100° C. of PAO4 solution containing Example 9.

### Evaluation of Diblock Copolymer Procedure

One gram of aPP-b-PBMA copolymer (Example 1), 0.015 gram of a commercial hindered phenol antioxidant (Trade name: Irganox 1076), 0.005 gram of another commercial phosphite antioxidant (Trade name; Irgafos 168), were dissolved in 98.98 grams of a Group II base oil (ExxonMobil Jurong 150) to make up a total of 100 grams of candidate solution.

This solution was subject to various viscosity measurements including kinematic viscosity (KV) at 25° C., 40° C. and 100° C. The thickening efficiency (TE) was calculated from the kinematic viscosity data at 100° C. and the Group II base oil viscosity at 100° C. The viscosity index (VI) was also calculated from both data of the KV at 40° C. and at 100° C. This solution was also subject to thermal-oxidative evaluation using pressurized differential scanning calorimetry (PDSC, 700 KPa oxygen pressure, 10° C. per minute ramping speed and 6.5 mg sample size) to measure onset temperature and thermal gravimetric analyzer (TGA, ramping from 40° C. to 600° C. at 10° C. per minute speed either under nitrogen or air) to monitor the high temperature residue formation. This solution was also evaluated for high temperature viscosity under shearing condition using the Ultra Shear viscometer. The high temperature high shear (HTHS) viscosity at 150° C. was recorded.

Similarly, one gram of a commercial viscosity modifier hydrogenated styrene-isoprene block copolymer (Trade name ShellVis 150), 0.015 gram of a commercial hindered phenol antioxidant (Trade name: Irganox 1076), 0.005 grain of another commercial phosphite antioxidant (Trade name; Irgafos 168), were dissolved in 98.98 grams of the same Group II base oil (ExxonMobil Jurong 150) to make up a total of 100 grams of reference solution. This reference oil was subject to the same evaluation protocols for comparison purposes.

As shown in Table 5, aPP-b-PBMA solution demonstrated good kinematic viscosity and VI (falling within the range of 60 to 194 for KV 25, 31 to 92 cSt for KV 40, 5.6 to 15.7 for KV 100 and 119 to 182 for VI), good thickening efficiency (1.6-1.9), reasonable PDSC oxidative stability and low TGA deposits. The HTHS viscosity at 150° C. is also decent (2.71 is staying within the range of 2.06-3.23 of references).

TABLE 5
(Evaluation of aPP-b-PBMA diblock copolymer)

| | ShellVis | aPP-b- |
|---|---|---|
| | 150 | PBMA |
| KV40 (cSt) | 54 | 62 |
| KV100 (cSt) | 10.2 | 10.2 |
| VI | 179 | 151 |
| TE | 1.86 | 1.86 |
| Onset of oxidation temperature | 204 | 193 |
| (° C.) | | |
| HTHS (cP) | 2.73 | 2.71 |

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in this art in light of the above detailed description. All such obvious variations are within the full intended scope of the appended

What is claimed is:

1. An alternating block copolymer, comprising:
an olefin polymer block including monomeric units of one or more alpha olefins of 2 to 12 carbon atoms, wherein the monomeric units of one or more alpha olefins of 2 to 12 carbon atoms make up 90 wt % or more of the total weight of the olefin polymer block, wherein the number average molecular weight of the olefin polymer block is 1000 to 500,000,
an poly(alkyl methacrylate) block including monomeric units of one or more alkyl methacrylates with alkyl side chains of 1 to 100 carbon atoms, wherein the monomeric units of one or more alkyl methacrylates make up 90 wt % or more of the total weight of the poly(alkyl methacrylate) block, wherein the number average molecular weight of the poly(alkyl methacrylate) block is 1000 to 500,000.

2. The copolymer of claim 1, wherein the monomeric units of one or more alpha olefins of 2 to 12 carbon atoms make up 95 wt % or more of the total weight of the olefin polymer block.

3. The copolymer of claim 1, wherein the monomeric units of one or more alkyl methacrylates with alkyl side chains of 1 to 100 carbon atoms make up 95 wt % or more of the total weight of the poly(alkyl methacrylate) block.

4. The copolymer of claim 1, wherein the number average molecular weight of each of the olefin polymer block and the poly(alkyl methacrylate) block is 2500 to 400,000.

5. The copolymer of claim 1, wherein the number average molecular weight of each of the olefin polymer block and the poly(alkyl methacrylate) block is 5000 to 300,000.

6. The copolymer of claim 1, wherein the copolymer is a diblock copolymer.

7. A lubricant composition, comprising:
a lubricant base stock and
0.1 wt % to 20 wt % of the alternating block copolymer of claim 1 based on the total weight of the composition.

8. The lubricant of claim 6, wherein the lubricant base stock comprises
one or more polyalphaolefins.

9. A process for making an alternating block copolymer of an olefin polymer block and an poly(alkyl methacrylate) polymer block, comprising:
(a) providing the olefin polymer block, wherein the olefin polymer block includes monomeric units of one or more alpha olefins of 2 to 12 carbon atoms making up 90 wt % or more of the total weight of the olefin polymer block and exhibits a number average molecular weight of 1000 to 500,000;
(b) preparing a olefin polymer block with chain end unsaturations;
(c) forming an ATRP macroinitiator with the chain-end unsaturated olefin polymer block to prepare an olefin polymer block macroinitiator; and
(d) reacting the olefin polymer block macroinitiator with one or more alkyl methacrylates with alkyl side chains of 1 to 100 carbon atoms to form the poly(alkyl methacrylate) block, wherein the one or more alkyl methacrylates with alkyl side chains of 1 to 100 carbon atoms make up of 90 wt % or more of the total weight of the poly(alkyl methacrylate) polymer block, and wherein the poly(alkyl methacrylate) polymer block exhibits a number average molecular weight of 1000 to 500,000.

10. The process of claim 9, wherein the olefin polymer block with chain end unsaturations is a vinyl-terminated olefin polymer block, wherein the vinyl-terminated olefin polymer block is formed by polymerizing one or more olefins in the presence of an organometallic catalyst and an activator.

11. The process of claim 10, wherein the olefin polymer block macroinitiator is formed by reacting the vinyl-terminated olefin polymer block with 2-bromoisobutyric acid.

12. The process of claim 9, wherein the olefin polymer block with chain end unsaturations is a vinylidene-terminated olefin polymer block.

13. The process of claim 9, wherein the monomeric units of one or more alpha olefins of 2 to 12 carbon atoms make up 95 wt % or more of the total weight of the olefin polymer block.

14. The process of claim 9, wherein the monomeric units of one or more alkyl methacrylates with alkyl side chains of 1 to 100 carbon atoms make up 95 wt % or more of the total weight of the poly(alkyl methacrylate) block.

15. The process of claim 9, wherein the number average molecular weight of each of the olefin polymer block and the poly(alkyl methacrylate) block is 2500 to 400,000.

16. The process of claim 9, wherein the number average molecular weight of each of the olefin polymer block and the poly(alkyl methacrylate) block is 5000 to 300,000.

17. The process of claim 9, wherein the copolymer is a diblock copolymer.
